(19) United States
(12) Patent Application Publication
(10) Pub. No.: US 2006/0288140 A1
(43) Pub. Date: Dec. 21, 2006

(54) Computer cable, junction box for use with computer cable

(76) Inventor: Te-Sung Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/156,620

(22) Filed: Jun. 21, 2005

(51) Int. Cl. G06F 13/00

(52) U.S. Cl. 710/100

(57) ABSTRACT

Disclosed is a computer cable, which includes a plurality of electric lines arranged in parallel and respectively extending out of two distal ends thereof, a first set of electric connectors respectively provided at one end of each of the electric lines for connection to the power connector and signal input/output ports of a computer, and a second set of electric for connection to computer peripheral apparatus to electrically connect the computer peripheral apparatus to the computer.

### BACKGROUND OF THE INVENTION

1. Field of the Invention

The present invention relates to computer cables and more particularly, to such a computer cable that is adapted to connect a variety of computer peripheral apparatus to a computer.

2. Description of the Related Art

Following fast development of computer technology, a variety of computer peripheral apparatus such as PDA, scanner, webcam, speaker, microphone, wired or wireless communication apparatus, and etc. have been disclosed for use with a computer system and have appeared on the market. When several computer peripheral apparatus are used with a computer system, the related cables must be properly arranged so as not to hinder people in working or passing by. In order to have a broad table-top working space, people usually will put the computer in one corner under the table with the cables of the connected computer peripheral apparatus arranged behind the table and the computer in a corner area inside the room. In this case, it is complicated to detach the cable of one computer peripheral apparatus from the computer, or to install a new computer peripheral apparatus.

### SUMMARY OF THE INVENTION

The present invention has been accomplished under the circumstances in view. According to one aspect of the present invention, a computer cable is provided for connecting a variety of computer peripheral apparatus to a computer. The computer cable comprises a plurality of electric lines arranged in parallel and respectively extending out of two distal ends thereof, a first set of electric connectors respectively provided at one end of each of the electric lines for connection to the power connector and signal input/output ports of a computer, and a second set of electric for connection to computer peripheral apparatus to electrically connect the computer peripheral apparatus to the computer. According to another aspect of the present invention, a junction box is used with the computer cable to hold the electric lines of the computer cable in good order for the connection of the cables of various different computer peripheral apparatus.

### BRIEF DESCRIPTION OF THE DRAWINGS

FIG. 1 is a perspective view of a computer cable according to the present invention.

FIG. 2 is a schematic drawing showing the collars moved relative to the signal lines of the computer cable according to the present invention.

FIG. 3 is a schematic drawing showing one application example of the present invention.

FIG. 4 is a schematic drawing showing the computer cable used with a junction box according to the present invention.

### DETAILED DESCRIPTION OF THE PREFERRED EMBODIMENT

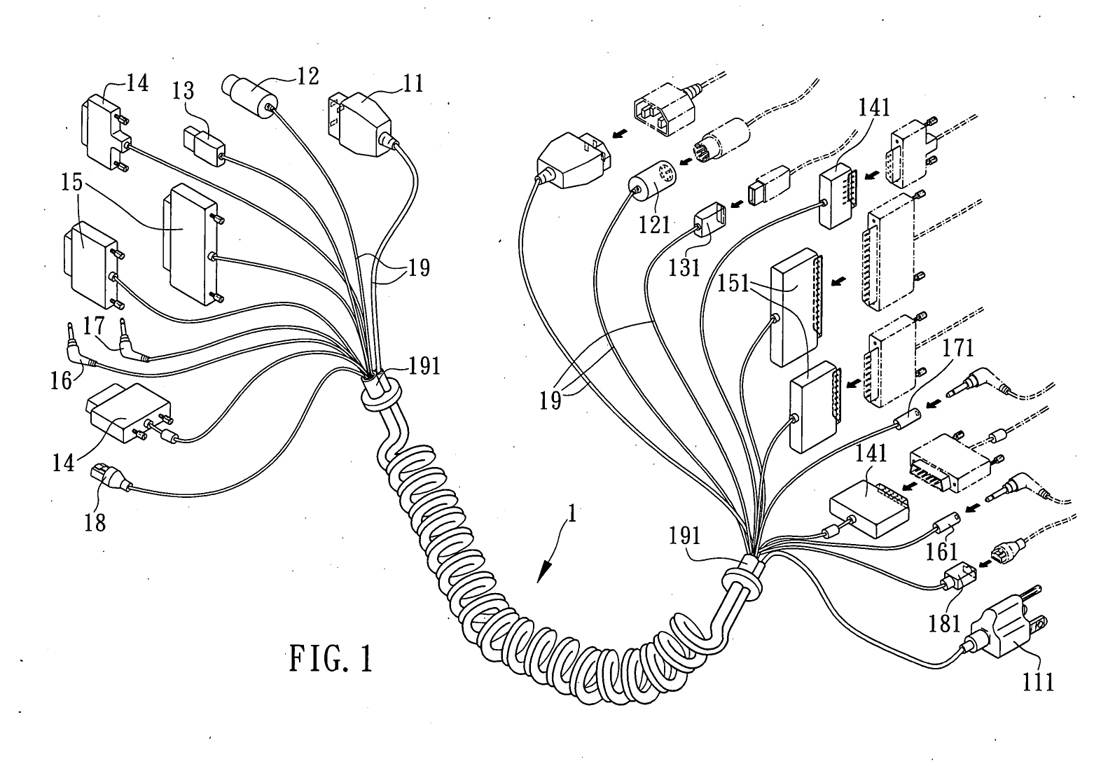

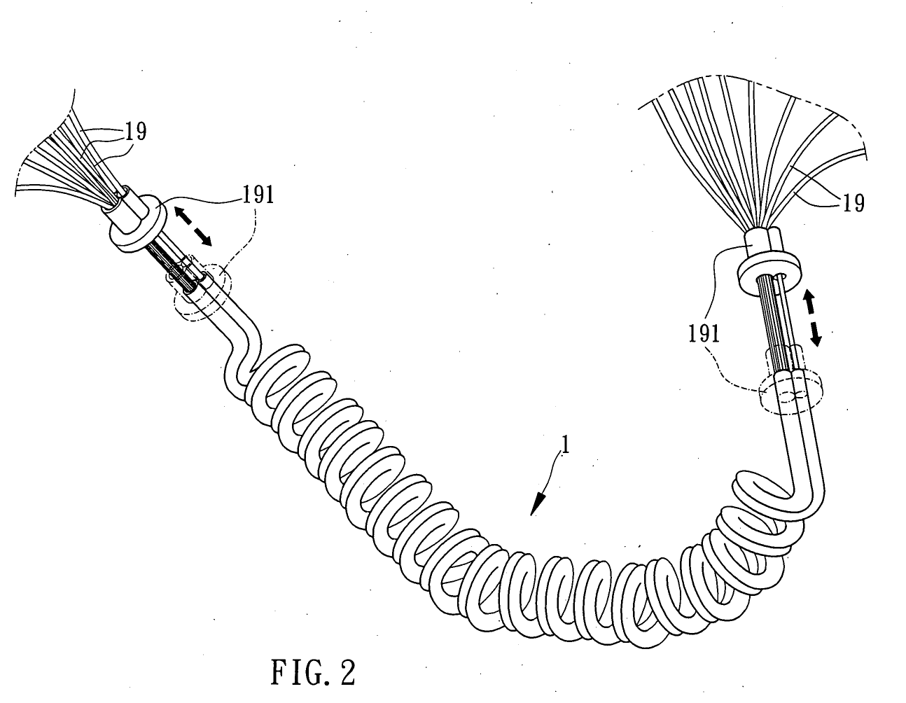

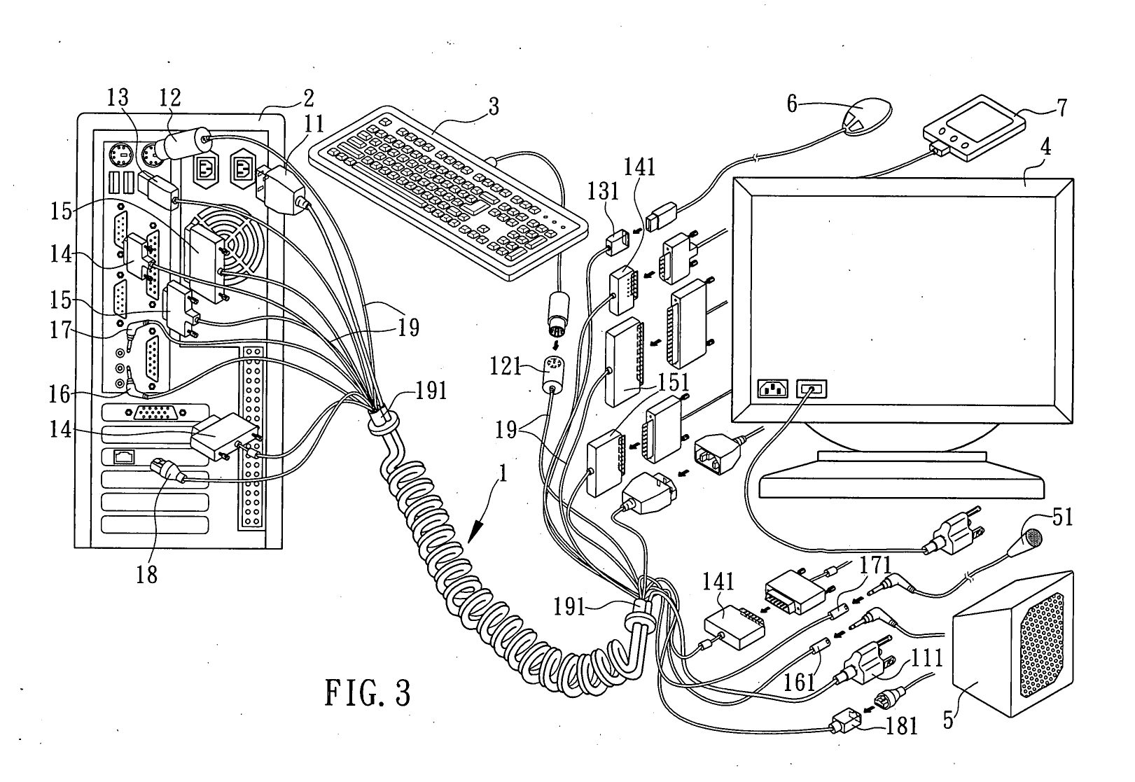

Referring to FIGS. 1-3, a computer cable 1 in accordance with the present invention is shown comprising a plurality of electric lines 19 arranged in parallel and respectively extending out of the two distal ends thereof, a first set of electric connectors including power connector 11, PS2 connector 14, USB connector 13, VGA connector 12, COM connector 15, network connector 18, speaker connector 16, microphone connector 17, and telephone connector respectively provided at one end of each of the electric lines 19 for connection to respective ports of a computer 2, and a second set of electric connectors including power connector 111, PS2 connector 141, USB connector 131, VGA connector 121, COM connector 151, network connector 181, speaker connector 161, microphone connector 171, and telephone connector respectively provided at the other end of each of the electric lines 19 for connection to the power jack and signal input port of one of a variety of computer peripheral apparatus such as computer monitor 4, mouse 6, PDA 7, keyboard 3, speaker 5, microphone 51, video camera, scanner, etc. By means of the use of the computer cable 1, a variety of computer peripheral apparatus can conveniently detachably connected to a computer. The invention eliminates the use of various different electric cables to connect different computer peripheral apparatus to a computer. Further, two collars 191 are respectively mounted around the electric lines 19 near two ends of the computer cable 1 and axially movable relative to the computer cable 1 to keep the electric lines 19 together or to let the electric lines 19 be spread out (see FIG. 2).

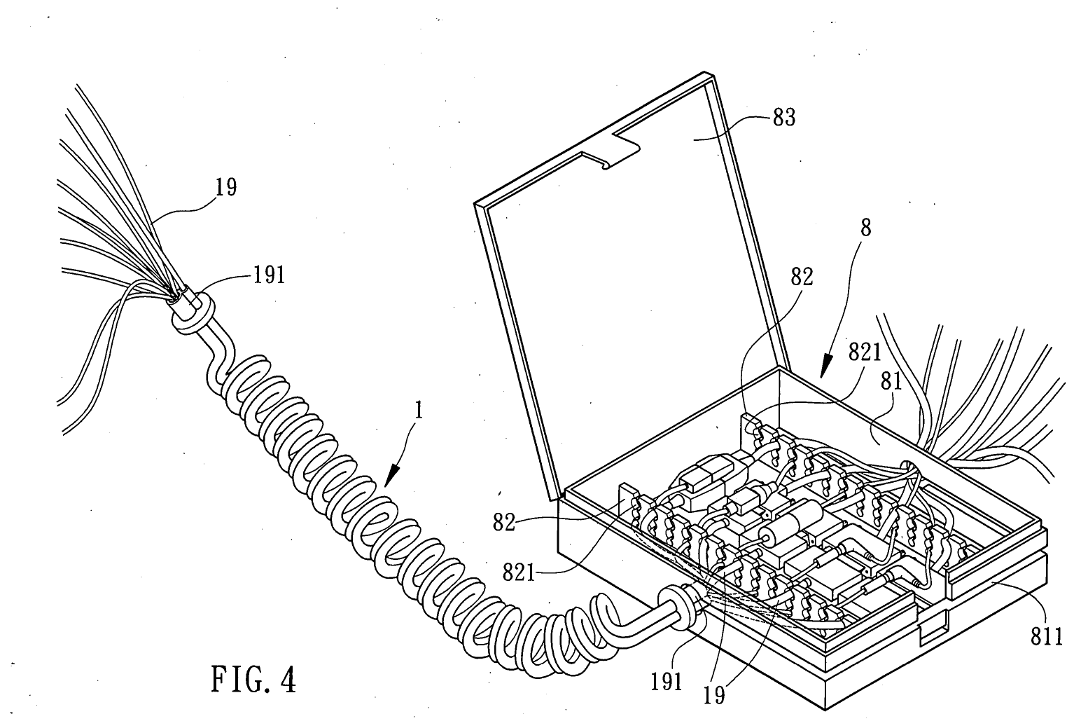

Referring to FIG. 4, the computer cable 1 may be used with a junction box 8. The junction box 8 comprises a box body 81 and a box cover 83. The box body 81 comprises two holder bars 82 arranged in parallel on the inside and spaced from each other at a distance, each holder bar 82 having a plurality of clamping mouths 821, and a transversely extending narrow opening 811 cut through the front and rear sidewalls and one lateral sidewall. Through the narrow opening 811, the electric lines 19 of the computer cable 1 are inserted into the inside of the box body 81 and respectively engaged into the clamping mouths 821 of one holder bar 82, and the cables of the computer peripheral apparatus can be inserted into the inside of the box body 81 and engaged into the clamping mouths 821 of the other holder bar 82 to have the respective electric connectors of the cables of the computer peripheral apparatus respectively electrically connected to the second set of electric connectors of the computer cable 1. After installation, the box cover 83 is closed on the box body 81.

Although particular embodiments of the invention have been described in detail for purposes of illustration, various modifications and enhancements may be made without departing from the spirit and scope of the invention.

What the invention claimed is:

1. A computer cable comprising a plurality of electric lines arranged in parallel and respectively extending out of two distal ends thereof, a first set of electric connectors respectively provided at one end of each of said electric lines for connection to the power connector and signal input/output ports of a computer, and a second set of electric for connection to computer peripheral apparatus to electrically connect said computer peripheral apparatus to said computer.

2. The computer cable as claimed in claim 1, wherein said first set of electric connectors and said second set of electric connectors each include a power connector, a PS2 connector, a USB connector, a VGA connector, a COM connector, a network connector, a speaker connector, a microphone connector, and a telephone connector.

3. The computer cable as claimed in claim 1, further comprising two collars respectively mounted around said electric lines near two ends of said computer cable and axially movable relative to said computer cable to selectively keep said electric lines together and let said electric lines be spread out.

4. A junction box for use with the computer cable as claimed in claim 1, comprising a box body and a box cover, said box body comprising two holder bars arranged in parallel on the inside thereof and spaced from each other at a distance, holder bars each having a plurality of clamping mouths for securing the electric lines of said computer cable and the cables of computer peripheral apparatus, and a transversely extending narrow opening cut through front and rear sidewalls and one lateral sidewall thereof for the passing of the electric lines of said computer cable and the cables of computer peripheral apparatus to access to the clamping mouths of said holder bars.
